(19) United States
(12) Patent Application Publication
(10) Pub. No.: US 2010/0102101 A1
(43) Pub. Date: Apr. 29, 2010

(54) Paper toweling dispenser apparatus

(75) Inventors: Joel P. Keily, Corona, CA (US); Niko Anthony Cvjetkovic, La Palma, CA (US); Patrick C. Perrin, Rancho Palos Verdes, CA (US); Michel Morand, Montreal (CA)

Correspondence Address: THOMAS R. LAMPE;BIELEN, LAMPE & THOEMING, 1390 WILLOW PASS ROAD, SUITE 1020, CONCORD, CA, 94520, US

(73) Assignee: Perrin Manufacturing Company

(21) Appl. No.: 12/290,220

(22) Filed: Oct. 28, 2008

(51) Int. Cl. A47K 10/36; A47K 10/26; A47K 10/38; B23D 25/02

(52) U.S. Cl. 225/10; 312/34.8; 242/564.1; 242/564.2

(57) ABSTRACT

Toweling dispenser apparatus including a toweling support roller carrying a movable cutter blade. A switch is actuated after a user pulls on toweling to rotate the toweling support roller and transport the toweling. After some rotation of the roller has occurred, an electric switch is closed and energizes an electric motor to drive the roller and reduce the force required by the user to rotate the roller and actuate the cutter blade to sever a towel from the toweling.

### TECHNICAL FIELD

This invention relates to apparatus for dispensing paper toweling from a roll of paper toweling. More particularly, the paper toweling dispenser incorporates an electric motor for facilitating dispensing of the toweling.

### BACKGROUND OF THE INVENTION

Many dispenser systems are known in the prior art for dispensing paper toweling from rolls thereof. In some cases, the paper toweling is comprised of individual paper towel segments separated by perforated tear lines, and in others the toweling has no perforated tear lines formed therein, severing or cutting individual sheets from the toweling accomplished by some suitable severing structure incorporated in the dispenser.

Many towel dispensers of a purely mechanical nature have been developed and utilized over the years for dispensing paper towels, including dispensers which are actuated by a user grasping and pulling on a tail of the toweling extending from the dispenser housing.

For example, U.S. Pat. Nos. 6,314,850 and 6,553,879 disclose apparatus for dispensing paper toweling including a rotatable toweling support roller and a cutter blade pivotally mounted on the outer peripheral portion of the roller. The blade is movable between a first position in which the cutting edge of the blade is positioned closely adjacent to the outer peripheral portion and a second position in which the blade is disposed at an angle relative to the outer peripheral portion with the cutting edge of the blade spaced from the toweling support roller. The cutter blade when in the second position projects in a direction generally opposed to the direction of rotation of the toweling support roller. Pulling force exerted on the toweling by a user not only serves to rotate the toweling support roller but also cause the toweling to bear against the cutting edge of the cutter blade to sever the toweling.

The apparatus of U.S. Pat. Nos. 6,314,850 and 6,553,879 has met with considerable commercial success; however, some problems with “tabbing” have occurred during use of the dispenser. Tabbing occurs when a piece of towel tears from the sheet when a user grasps and pulls the paper. Tabbing may occur with one or two hand pulls. Papers that absorb water at the greatest rate are most likely to tab, the rate of water absorbency varying by paper manufacturer and grade. Tabbing also becomes a particular problem when low basis weight paper is to be dispensed. It is not an exaggeration to say that virtually all paper towel dispensers of a purely mechanical nature which rely on direct pulling of the toweling by a user to transport the toweling and actuate moveable cutter or severing blades have a tabbing problem to some extent.

Electro-mechanical dispensers employing an electric motor to transport toweling and actuate cutter mechanisms are also well known. Such arrangements include both dispensers which are manually actuated, as by means of a push button and those employing a sensor, such as a sensor sensing proximity of a user's hand, to initiate operation.

U.S. Pat. No. 6,820,785, issued Nov. 23, 2004, discloses an electro-mechanical roll towel dispenser including a housing with a roll carrier disposed therein to rotationally support a roll of towel material. An electro-mechanical feed mechanism is disposed in the housing to dispense measured sheets of the towel material. The feed mechanism operates in a first mechanical operational mode wherein the towel sheets are dispensed by a user grasping and pulling on a tail of the towel material extending from the housing, and a second electrical operational mode wherein a measured length of a next sheet is automatically fed from the housing to define the tail for the next user.

The dispenser of U.S. Pat. No. 6,820,785 includes a sensor for detecting a parameter that is changed by an initial pull exerted on a tail of a web of material extending from the opening of the dispenser. The sensor also generates a signal sent from the sensor to a control circuit or circuitry causing the motor employed in the apparatus to drive the feed mechanism until a measured length of web material that includes the tail of web material has been fed from the dispenser in the form of a measured sheet for subsequent removal by the user.

Similar devices are disclosed in U.S. Pat. No. 3,730,409 and Patent Publication Document WO 00/63100. The devices of these latter two documents have sensors for detecting movement of a tail end of web material such that the feed mechanism is activated in response to detecting the movement.

The following documents are also believed to be representative of the current state of the prior art in this field: U.S. Pat. No. 3,715,085, issued Feb. 6, 1973, U.S. Pat. No. 3,730,409, issued May 1, 1973, U.S. Pat. No. 3,737,087, issued Jun. 5, 1973, U.S. Pat. No. 3,949,918, issued Apr. 13, 1976, U.S. Pat. No. 3,998,308, issued Dec. 21, 1976, U.S. Pat. No. 4,666,099, issued May 19, 1987, U.S. Pat. No. 4,676,131, issued Jun. 30, 1987, U.S. Pat. No. 4,721,265, issued Jan. 26, 1988, U.S. Pat. No. 4,738,176, issued Apr. 19, 1988, U.S. Pat. No. 4,790,490, issued Dec. 13, 1988, U.S. Pat. No. 4,796,825, issued January, 1989, U.S. Pat. No. 4,960,248, issued Oct. 2, 1990, U.S. Pat. No. 5,131,302, issued Jul. 21, 1992, U.S. Pat. No. 5,452,832, issued Sep. 26, 1995, U.S. Pat. No. 5,772,291, issued Jun. 30, 1998, U.S. Pat. No. 6,079,305, issued Jun. 27, 2000, U.S. Pat. No. 6,105,898, issued Aug. 22, 2000, U.S. Pat. No. 6,412,655, issued Jul. 2, 2002, U.S. Pat. No. 6,412,679, issued Jul. 2, 2002, Patent Document No. WO 9959457, dated November, 1999, Patent Document No. WO 0063100, dated October, 2000, U.S. Pat. No. 7,398,944, issued Jul. 15, 2008, U.S. Pat. No. 6,892,620, issued May 17, 2005, U.S. Pat. No. 7,044,421, issued May 16, 2006, U.S. Pat. No. 4,573,750, issued Mar. 4, 1986, U.S. Pat. No. 4,826,262, issued May 2, 1989, U.S. Pat. No. 6,446,901, issued Sep. 10, 2002, U.S. Pat. No. 4,270,818, issued Jun. 2, 1981, U.S. Pat. No. 6,112,631, issued Sep. 5, 2000, U.S. Pat. No. 5,375,920, issued Dec. 27, 1994, U.S. Pat. No. 7,354,015, issued Apr. 8, 2008, U.S. Pat. No. 4,738,176, issued Apr. 19, 1988, U.S. Pat. No. 790,490, issued Dec. 13, 1988, U.S. Pat. No. 6,079,305, issued Jun. 27, 2000, U.S. Pat. No. 6,419,136, issued Jul. 16, 2002, U.S. Pat. No. 6,412,679, issued Jul. 2, 2002, U.S. Pat. No. 5,441,189, issued Aug. 15, 1995, U.S. Pat. No. 5,878,381, issued Mar. 2, 1999, U.S. Pat. No. 5,691,919, issued Nov. 25, 1997, U.S. Pat. No. 5,452,832, issued Sep. 26, 1995, U.S. Pat. No. 5,340,045, issued Aug. 23, 1994, U.S. Pat. No. 5,335,811, issued Aug. 9, 1994, U.S. Pat. No. 5,244,263, issued Sep. 14, 1993, U.S. Pat. No. 4,848,854, issued Jul. 18, 1989, U.S. Pat. No. 4,738,176, issued Apr. 19, 1988, U.S. Pat. No. 4,270,818, issued Jun. 2, 1981, U.S. Pat. No. 4,170,390, issued Oct. 9, 1979, U.S. Pat. No. 5,657,945, issued Aug. 19, 1997, U.S. Pat. No. 4,122,738, issued Oct. 31, 1978, U.S. Pat. No. 6,012,664, issued Jan. 11, 2000, U.S. Pat. No. 5,816,514, issued Oct. 6, 1998, U.S. Pat. No. 5,417,783, issued May 23, 1995, U.S. Pat. No. 4,717,043, issued Jan. 5, 1988, U.S. Pat. No. 5,630,526, issued May 20, 1997 and U.S. Pat. No. 6,363,824.

### DISCLOSURE OF INVENTION

The present invention relates to a paper toweling dispenser apparatus which is electro-mechanical in nature to provide electric motor assisted dispensing and which is relatively simple, inexpensive and reliable as compared to prior art electro-mechanical towel dispenser systems. Furthermore, the invention disclosed and claimed herein virtually eliminates “wet hand tabbing” even when low basis weight paper is to be dispensed.

The invention incorporates a motor which reduces pull force which must be exerted by a user of the apparatus during dispensing. Initial transport of the toweling is accomplished by the user exerting a pull force of very low magnitude. On the other hand, when cutting of toweling is occurring, which normally requires application of a relatively high pull force, during which tabbing is most likely, an electric motor employed in the apparatus provides assistance, reducing the pull force that would otherwise have to be applied by a consumer.

In addition, the apparatus incorporates dual mode functioning; that is, when the batteries normally utilized to energize the motor deplete, toweling can still be cut and accessed by a user rotating a feed knob to advance the tail. The user can remove the sheet by pulling on the tail as usual. A key to maintaining low pull force in this mode is to disengage the gear motor from the toweling support roller through the use of a one-way clutch bearing or other clutch system such as pawls.

The user can manually turn the feed knob or handle until the sheet is cut and advanced. If the toweling is completely cut by the cutting mechanism, the severed sheet can be fully advanced and can be removed by the user without pulling required or, if the toweling is partly severed, the user can rotate the knob to advance a tail and then pull on the tail. In addition, the knob may be utilized to rotate the toweling support roller and toweling thereon until the motor is energized, rather than the user directly manually applying pulling forces on the tail to accomplish this.

Furthermore, the motor eliminates the need for toweling support roller return springs, an expedient employed in U.S. Pat. No. 6,314,850, for example, to return the toweling support roller to an initial or rest position, again providing a reduction of required pull force and consequent tabbing. In the arrangement of U.S. Pat. No. 6,314,850, the springs must be tensioned during initial rotation of the toweling by manually pulling the toweling. This requires higher pulling forces, increasing the likelihood of tabbing.

Activation and deactivation of the electric motor is accomplished by means of a simple switch, thus no circuit board or complicated sensor/control circuitry is required.

The paper toweling dispenser apparatus of the present invention includes a roll support for rotatably supporting a roll of paper toweling.

A rotatable toweling support roller is spaced from the roll support for receiving paper toweling from the roll of paper toweling, the toweling support roller having a cylindrically-shaped outer peripheral surface.

An electric motor is operatively associated with the toweling support roller for selectively rotating the toweling support roller.

The apparatus also includes an electric switch operatively associated with the electric motor and with the toweling support roller. The electric switch is responsive to rotation of the toweling support roller by a user of the paper towel dispenser apparatus to a first position to energize the electric motor when the toweling support roller reaches the first position and cause rotation of the rotatable toweling support roller by the electric motor from the first position to a second position and reducing the pull force required by a user pulling the paper toweling during rotation of the toweling support roller between the first position and the second position. The electric switch is responsive to rotation of the toweling support roller beyond the second position to de-energize the electric motor.

Other features, advantages and objects of the present invention will become apparent with reference to the following description and accompanying drawings.

### BRIEF DESCRIPTION OF DRAWINGS

FIG. 1 is a perspective view of apparatus constructed in accordance with the teachings of the present invention, the outer cabinet having been removed;

FIG. 2 is a view similar to FIG. 1, but illustrating a battery cover removed to illustrate batteries, and a finger guide plate pivoted from its normal position shown in FIG. 1 wherein it partially surrounds and covers the toweling support roller;

FIG. 3 is an enlarged, perspective view illustrating a motor driven drive gear with the teeth thereof meshing with teeth of a circular toweling support roller gear, only a portion of the latter being illustrated;

FIG. 4 is a side, elevational view of the apparatus and showing in dash lines relative placement of a cam follower of blade actuator structure of the invention positioned relative to a channel of a cam during a stage of operation wherein an electric motor is utilized to rotate the toweling support roller;

FIG. 5 is a diagrammatic presentation illustrating the condition of structural elements of the apparatus at the point of operation where a user has grasped the tail of toweling and initiates pulling;

FIG. 6 illustrates the condition of structural components of the invention when pulling is initiated by the hand of a user grasping the toweling tail during the stage of operation shown in FIG. 5;

FIG. 7 is a view similar to FIG. 5, but illustrating a stage of operation of the apparatus wherein a cutter blade is in severing position and the electric motor is energized to reduce the pulling forces required by the user;

FIG. 8 is a view similar to FIG. 6, but illustrating the condition of structural components in the stage of operation of FIG. 7;

FIG. 9 is a view similar to FIGS. 5 and 7, but showing the endmost sheet of toweling having been severed by the blade and the electric motor still operating to rotate the toweling support roller;

FIG. 10 is a view similar to FIGS. 6 and 8 showing the condition of the structural elements of the apparatus in the stage of operation of FIG. 9;

FIG. 11 is a view similar to FIGS. 5, 7 and 9 illustrating the toweling support roller further rotated, the motor de-energized, and a new tail end in the process of being presented to be grasped by a user; and

FIG. 12 is a view similar to FIGS. 6, 8 and 10 showing the condition of the structural elements of the apparatus in the stage of operation illustrated in FIG. 11, the electric motor having been de-energized and momentum in the process of returning the toweling support roller to its initial or rest position.

### BEST MODE FOR CARRYING OUT THE INVENTION

Referring now to the drawings, paper toweling dispenser apparatus constructed in accordance with the teachings of the present invention is illustrated, the apparatus for dispensing paper toweling from a roll of paper toweling R. The apparatus includes a housing 10 which is suitably positioned in an outer paper towel dispenser cabinet (not shown) and secured thereto by any suitable expedient such as screws or other suitable mechanical fasteners.

A roll support is operatively associated with the housing 10 to rotatably support a roll of paper toweling R (FIG. 4) in a conventional fashion. Toweling 12 from the roll is shown in FIGS. 4, 5, 7, 9 and 11 and identified by reference numeral 12. As is conventional, the disclosed roll support includes two double-ended arms 14, 16 spaced from one another and roll engagement members 18 at the distal or upper ends of the arms for entering the ends of the roll.

A rotatable toweling support roller 22 is rotatably mounted within the housing 10 for receiving toweling 12 and supporting and transporting the toweling. The rotatable toweling support roller 22 has a cylindrically-shaped outer peripheral surface and is rotatable in a predetermined direction of rotation when pulling forces are applied to the toweling supported thereby. Stub shafts project from the ends of the toweling support roller and in turn are supported by the housing. A cutter blade 26 is pivotally connected to the toweling support roller. Cutter blade 26 has attached to the ends thereof cam followers 30, each including a cam follower arm 32 and a roller 34. Each roller 34 rides in a channel 36 of a cam 38. Cams 38 are located at both ends of the housing, it being understood that the channels 36 of these cams are directed inwardly.

Rotation of toweling support roller 22 will cause the cam followers to move along the cam surfaces defining channels 36. This, in turn, will cause the cutter blade 26 to pivot relative to the toweling support roller 22.

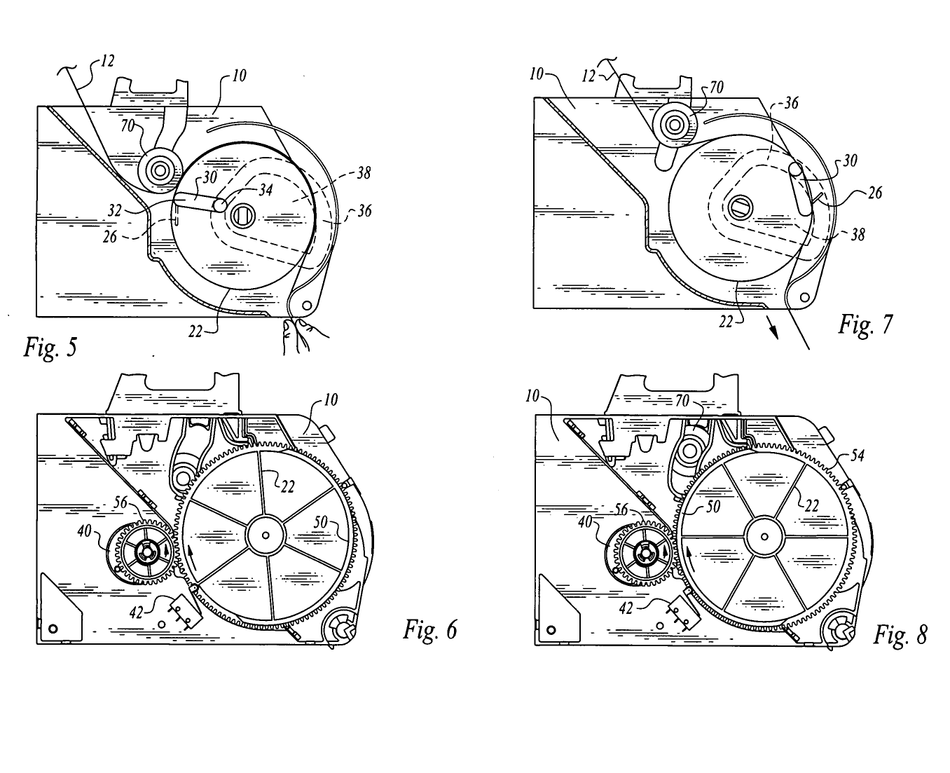

The cutter blade is movable between an inactive position (shown in FIG. 5) wherein the cutter will not sever the toweling and a severing position (see FIG. 7) wherein the cutting edge of the cutter blade is positioned outwardly of the toweling support roller to at least partially sever the toweling on the toweling support roller, an operation which will be described below.

The dispenser apparatus structure described thus far is essentially that disclosed in U.S. Pat. Nos. 6,314,850 and 6,553,879. As disclosed in those patents, the cutter blade when in its inactive or first position lies substantially flat against the toweling support roller with the cutting edge positioned closely adjacent to the cylindrically-shaped outer peripheral surface and a severing or second position wherein the cutting edge of the blade is positioned outwardly of the toweling support roller and disposed at an angle relative to the outer peripheral surface thereof. The cutter blade when in the second position, projects from the pivot in a direction generally opposed to the direction of rotation of the toweling support roller.

In the paper toweling dispenser apparatus disclosed and claimed herein, an electric motor 40 is operatively associated with the toweling support roller to selectively rotate the toweling support roller.

In addition, an electric switch 42 is operatively associated with the electric motor and with the toweling support roller. The electric switch is electrically connected to the electric motor, with no control circuit boards intermediate the electric motor and the electric switch.

The electric switch 42 is responsive to rotation of the toweling support roller 22 by a user of the paper towel dispenser from a rest or inactive position to a first position to energize the electric motor when the toweling support roller reaches the first position and cause rotation of the toweling support roller by the electric motor from the first position to a second position and reducing the pull force required by a user pulling the paper toweling during rotation of the toweling support roller between the first position and the second position. Further, the electric switch is responsive to rotation of the toweling support roller beyond the second position to de-energize the electric motor. This operation is described in more detail below.

Electric switch 42 includes a switch actuator element 44 having a roller 46 at the end thereof which is biased into engagement with a circular end 48 of the toweling support roller 22. The switch actuator element alternatively opens or closes the switch during rotation of the toweling support roller.

Located at circular end 48 of the toweling support roller and engaged by the switch actuator element roller during rotation of the toweling support roller is an arcuate projection 50. The projection extends only part way along the periphery of the toweling support roller and has two tapered projection ends 52.

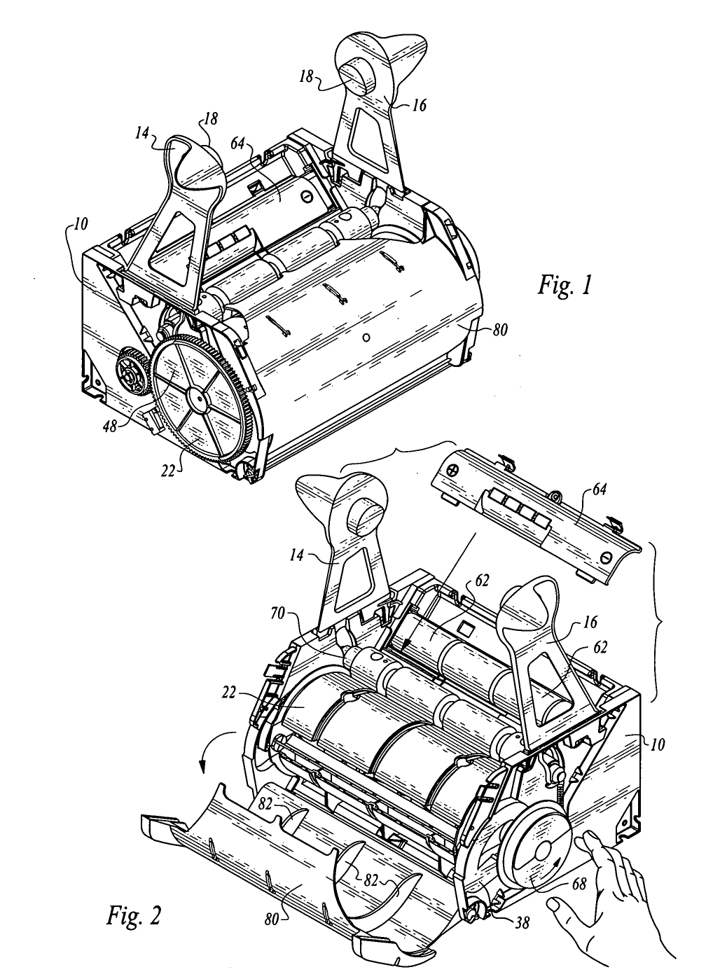

Extending completely about circular end 48 and disposed inwardly of the arcuate projection, is a toweling support roller gear 54 having teeth. Meshing with the teeth of the toweling support roller gear are teeth of a drive gear 56 which is driven by electric motor 40, the latter suitably being in the form of a DC gear motor. A one-way clutch needle bearing 58 connects the drive gear to the electric motor to allow the performance of certain functions indicated below. Electric wiring 60 connects the switch 42 to the electric motor. The electric switch is located between the electric motor and a source of DC power in the form of electric batteries 62 (see FIG. 2). In the interest of simplicity, the conventional wiring extending between the switch and the batteries is not illustrated. The batteries are normally covered by a cover plate 64 readily snapped into or out of position as depicted in FIGS. 1 and 2.

FIGS. 5 through 12 provide an illustration of the operation of the dispenser apparatus, including a dash line illustration in FIGS. 5, 7, 9 and 11 of the location of the blade and follower during consecutive stages in the operation of the apparatus.

FIGS. 5 and 6 illustrate the condition of the various components when pulling of toweling 12 by a user begins.

The toweling tail may be brought to the position illustrated in FIG. 5 by manually rotating the toweling dispenser roller 22 by a rotatable manually engageable element in the form of a handle or knob 68 connected to the toweling support roller. A one-way clutch (not shown) may be employed to ensure that the toweling support roller is being rotated in a direction to advance the toweling. The handle 68 can also be used to advance and dispense the toweling if the batteries fail. The user can pull on the tail as usual when not utilizing the apparatus in motor assisted mode. In this non-motor-driven mode, the required pull force is still relatively low since the gear motor is in effect disengaged from the toweling support roller by employing the one-way clutch needle bearing 58 or some other suitable one-way clutch mechanism.

Continued pulling of the toweling tail results in the condition illustrated in FIGS. 7 and 8. The switch 42 is closed since the switch actuator element 44 engages projection 50. Thus, the motor is energized and drives the toweling support roller gear and drive gear as shown by the arrows in FIG. 8. This results in significant reduction in the pulling force that would otherwise be required by the user pulling the toweling tail, greatly reducing the problem of tabbing. It will be appreciated that the motor is energized when the pulling forces necessary would otherwise be at their greatest, since the cutting blade is being moved into its severing position as shown in FIG. 7.

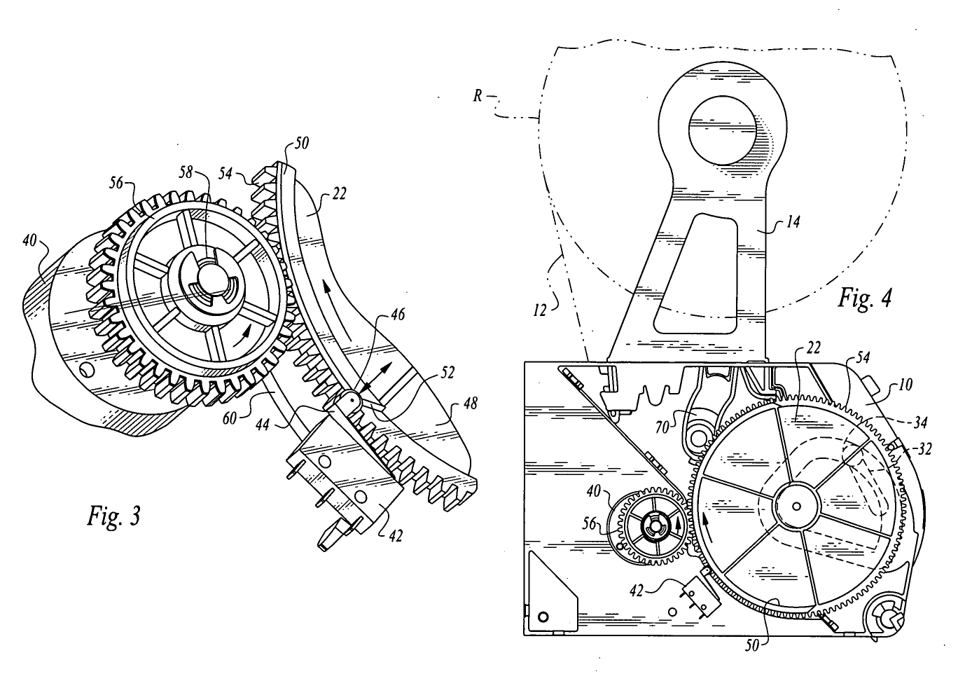

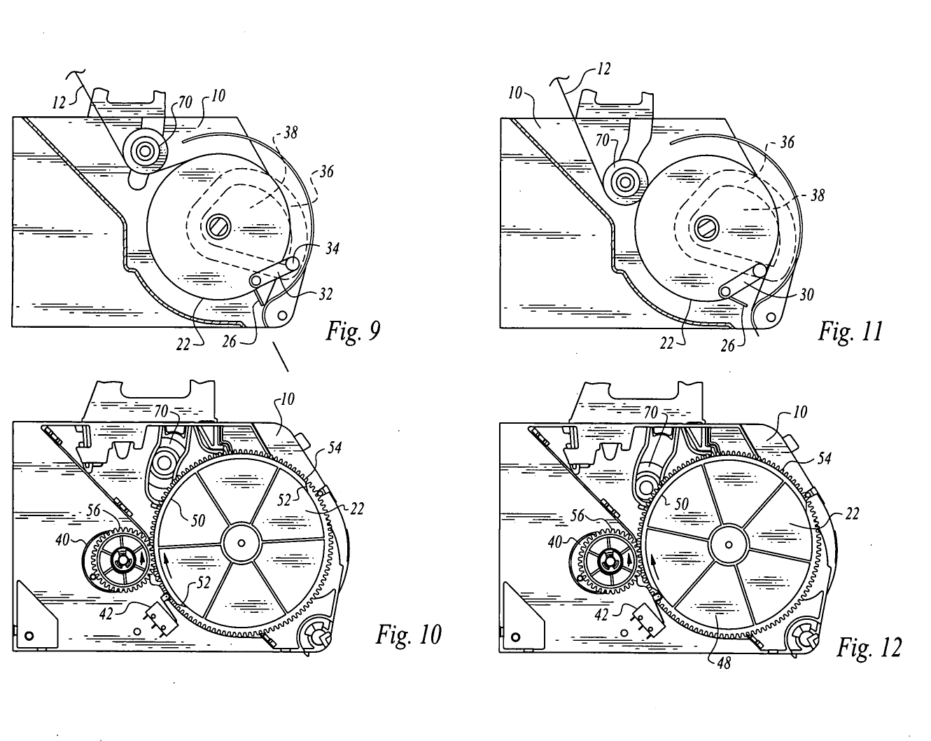

FIGS. 9 and 10 show the condition of the structural components when an individual towel has been severed from the toweling and a new tail end is in the process of being presented to the user. In the arrangement illustrated, and as disclosed in U.S. Pat. Nos. 6,314,850 and 6,553,879, severing is accomplished by the user pulling on the tail when the blade is at the angled position represented in FIG. 7. As indicated in FIG. 10, after severing, the motor will continue to rotate the toweling support roller to advance the next tail. This continues until the structural elements reach the condition shown in FIGS. 11 and 12 wherein the switch is opened to de-energize the electric motor during or after passage of the rearmost tapered end of the projection 50 past the switch. FIG. 3 shows the switch actuator element 44 just prior to passage of the rearmost projection end 52. The tapered projection ends facilitate engagement with the arcuate projection and disengagement therefrom. After de-energization, the momentum of the toweling support roller will bring it back to its initial inactive or rest position until the newly presented tail is pulled to again begin dispensing. The one-way clutch employed in the drive gear 56 results in the de-energized electric motor not impeding this final movement of the toweling support roller.

The toweling dispenser apparatus includes another feature which also reduces likelihood of tabbing. A shock reducing element in the form of a freely rotatable roller 70′ mounted for up and down movement within slots formed in opposed sides the housing is located in the path of the paper toweling extending between the toweling support roller and the roll support. If slack exists in the toweling, as illustrated for example in FIG. 5, pulling and consequent tautening of the toweling will cause the roller 70 to move upwardly as shown in FIG. 7. This reduces pulling forces at the tail distal end which might otherwise occur as a result from the shock resulting from taking up of the slack during pulling.

A curved plate 80 having curved pressure fingers 82 is pivotally attached to housing 10 and is movable between an open position (FIG. 2) and a closed position (FIG. 1). When in the closed position, the fingers are used to exert a downward force on the toweling on toweling support roller 22 to facilitate cutting of the toweling. If complete cutting or severing of a sheet from the toweling is desired without the user pulling on the sheet to tension it against the blade, a finger or fingers may be designed to hold the paper toweling in firm engagement with the surface of the toweling support roller.

By changing the configuration of the projection 50, the lengths of the tails projecting from the dispenser can be changed. Also, actual total sheet length can be changed by employing toweling support rollers of different drum diameters.

The invention claimed is:

1. Paper toweling dispenser apparatus for dispensing paper toweling from a roll of paper toweling, said apparatus comprising, in combination:
a roll support for rotatably supporting the roll of paper toweling;
a rotatable toweling support roller for receiving paper toweling from the roll of paper toweling, said toweling support roller having a cylindrically-shaped outer peripheral surface;
an electric motor operatively associated with said toweling support roller for selectively rotating said toweling support roller; and
an electric switch operatively associated with said electric motor and with said toweling support roller, said electric switch responsive to rotation of said toweling support roller by a user of the paper towel dispenser to a first position to energize said electric motor when the toweling support roller reaches said first position and cause rotation of said rotatable toweling support roller by said electric motor from said first position to a second position and reducing the pull force required by a user pulling said paper toweling during rotation of said toweling support roller between said first position and said second position, and said electric switch responsive to rotation of said toweling support roller beyond said second position to de-energize said electric motor.

2. The paper toweling dispenser apparatus according to claim 1 wherein said electric switch includes a switch actuator element engageable with said toweling support roller to alternatively open or close said switch during rotation of said toweling support roller.

3. The paper toweling dispenser apparatus according to claim 2 wherein said toweling support roller includes a projection, said switch actuator element alternatively being engaged with said projection or disengaged from said projection during rotation of said toweling support roller.

4. The paper toweling dispenser apparatus according to claim 3 wherein said projection is arcuate and located at an end of said toweling support roller.

5. The paper toweling dispenser apparatus according to claim 4 wherein said projection has tapered projection ends.

6. The paper toweling dispenser apparatus according to claim 1 additionally comprising a rotatable manually engageable element connected to said toweling support roller enabling a user to manually rotate said toweling support roller to advance said paper toweling.

7. The paper toweling apparatus according to claim 1 including a drive gear having teeth rotatable by said electric motor and wherein said toweling support roller includes a toweling support roller gear having teeth, the teeth of said drive gear engaging the teeth of said toweling support roller gear whereby said electric motor is operable to drive said toweling support roller when energized.

8. The paper toweling apparatus according to claim 7 including a one-way clutch enabling said toweling support roller to be manually rotated in one direction of rotation with substantially no electric motor drag.

9. The paper toweling apparatus according to claim 1 additionally comprising a cutter blade pivotally mounted on said toweling support roller and blade actuator structure for moving said cutter blade during rotation of said toweling support roller to at least partially sever paper toweling on said toweling support roller during rotation of said toweling support roller.

10. The paper toweling dispenser apparatus according to claim 9 wherein said blade actuator structure includes a cam follower attached to said blade and cam structure accommodating said cam follower, said cam follower moving in said cam structure during rotation of said toweling support roller to at least partially sever paper toweling being transported by said toweling support roller when said toweling support roller is rotating between said first position and said second position.

11. The paper toweling dispenser apparatus according to claim 10 wherein said cutter blade is pivotally mounted on said toweling support roller and is movable between an inactive position wherein said cutter blade will not sever said paper toweling and a severing position wherein a cutting edge of the cutter blade is positioned outwardly of said toweling support roller to at least partially sever the paper toweling on said toweling support roller.

12. The paper toweling dispenser apparatus according to claim 11 wherein said cutter blade moves to the inactive position while momentum of the toweling support roller moves the toweling support roller beyond the second position and the electric motor is de-energized.

13. The paper toweling dispenser according to claim 1 additionally comprising a movable shock reducing element for engaging paper toweling extending between said roll support and said toweling support roller and displacable upon tautening of said paper toweling during pulling of said paper toweling.

14. The paper toweling dispenser according to claim 1 wherein said electric motor is electrically connected to said electric switch with no control circuit board intermediate the electric motor and the electric switch.
